(19) United States
(12) Patent Application Publication
(10) Pub. No.: US 2018/0165853 A1
(43) Pub. Date: Jun. 14, 2018

(54) HEAD-MOUNTED DISPLAY APPARATUS AND VIRTUAL OBJECT DISPLAY SYSTEM

(71) Applicant: FUJI XEROX CO., LTD., TOKYO (JP)

(72) Inventors: Seiya INAGI, Kanagawa (JP); Teppei AOKI, Kanagawa (JP); Daisuke YASUOKA, Kanagawa (JP); Tadaaki SATO, Kanagawa (JP); Kazunari HASHIMOTO, Kanagawa (JP); Hidetaka IZUMO, Kanagawa (JP); Yusuke YAMAURA, Kanagawa (JP)

(73) Assignee: FUJI XEROX CO., LTD., TOKYO (JP)

(21) Appl. No.: 15/658,407

(22) Filed: Jul. 25, 2017

(30) Foreign Application Priority Data
Dec. 13, 2016 (JP) 2016-241183

(51) Int. Cl. G06T 11/60; G02B 27/01; G06F 3/01

(52) U.S. Cl. CPC G06T 11/60; G06F 3/017; G06F 3/011; G02B 27/0172

(57) ABSTRACT

A head-mounted display apparatus includes a capturing unit that captures an image of a real space, a transmissive display through which the real space is able to be visually perceived, and a drawing controller that controls such that a wall-shaped opaque virtual object is drawn so as to block visibility of a user based on the image captured by the capturing unit and the virtual object is displayed on the transmissive display as if the virtual object is present in the real space.

### CROSS-REFERENCE TO RELATED APPLICATIONS

This application is based on and claims priority under 35 USC 119 from Japanese Patent Application No. 2016-241183 filed Dec. 13, 2016.

### BACKGROUND

### Technical Field

An exemplary embodiment of the invention relates to a head-mounted display apparatus, and a virtual object display system.

### SUMMARY

According to an aspect of the present invention, there is provided a head-mounted display apparatus including: a capturing unit that captures an image of a real space; a transmissive display through which the real space is able to be visually perceived; and a drawing controller that controls such that a wall-shaped opaque virtual object is drawn so as to block visibility of a user based on the image captured by the capturing unit and the virtual object is displayed on the transmissive display as if the virtual object is present in the real space.

### BRIEF DESCRIPTION OF THE DRAWINGS

Exemplary embodiment(s) of the present invention will be described in detail based on the following figures, wherein:

FIG. 1 is a diagram showing a system configuration of a virtual object display system according to an exemplary embodiment of the present invention;

FIG. 2 is a diagram showing a hardware configuration of an HMD 10 shown in FIG. 1;

FIG. 3 is a block diagram showing a functional configuration of the HMD 10 according to the exemplary embodiment of the present invention;

FIG. 4 is a diagram showing an external appearance of the HMD 10 according to the exemplary embodiment of the present invention;

FIG. 5 is a diagram for describing a state in a case where the HMD 10 is worn;

FIG. 6 is a flowchart for describing an operation in a case where a display command of a virtual object is received in the HMD 10 according to the exemplary embodiment of the present invention;

FIG. 7 is a diagram showing an example of size designation of the generated virtual object;

FIG. 8 shows an example of a dimension diagram in a case where the generated virtual object 70 is viewed from the top;

FIG. 9 is a diagram showing an example of a top view of the virtual object 70 when the virtual object 70 is displayed;

FIG. 10 is a perspective view in a case where a state in which the virtual object 70 is displayed is diagonally viewed from the back;

FIG. 11 is a schematic diagram showing a state of visibility of a user before the virtual object 70 is displayed on a display 35;

FIG. 12 is a schematic diagram showing a state of the visibility of the user after the virtual object 70 is displayed on the display 35;

FIG. 13 is a diagram for describing an operation example when color of the virtual object 70 is changed;

FIG. 14 is a diagram for describing an operation example when a height of the virtual object 70 is changed;

FIG. 15 is a diagram for describing an operation example when a display position of the virtual object 70 is changed;

FIG. 16 is a diagram showing a case where character information such as “earthquake early warning is received!” is displayed on the virtual object 70;

FIG. 17 is a diagram showing a case where character information such as “person is approaching!” is displayed on the virtual object 70;

FIG. 18 is a diagram for describing a state in which a surface of the virtual object 70 intersecting with an approaching person 80 is changed to be translucent;

FIGS. 19A and 19B are diagrams for describing a state in which a surface of the virtual object 70 intersecting with a fingertip is changed to be translucent;

FIG. 20 is a diagram for describing a state in which the virtual object 70 is also displayed on the HMD 10 of another user 90 different from a user who displays the virtual object 70 and is at work;

FIG. 21 is a diagram for describing a state in which the displayed virtual object 70 is changed to be translucent in a case where it is determined that distances of two HMDs 10 approach each other within a preset distance; and

FIG. 22 is a diagram for describing a state in which another virtual object 71 is also displayed in front of the virtual object 70 in a case where a depth distance of the other virtual object 71 is farther than the display position of the virtual object 70.

### DETAILED DESCRIPTION

Hereinafter, an exemplary embodiment of the present invention will be described in detail with reference to the drawings.

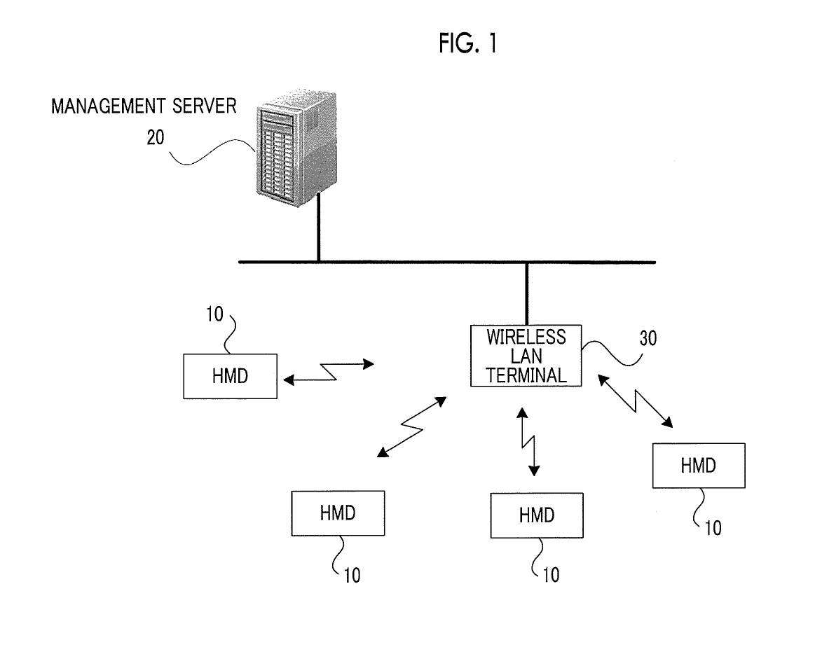

FIG. 1 is a diagram showing a system configuration of a virtual object display system according to an exemplary embodiment of the present invention.

In recent years, virtual reality (VR) that allows a user to visually perceive as if the user exists in a virtual space to the user by using a head-mounted display (hereinafter, abbreviated to HMD) is realized by various device.

However, in the VR technology, visual information of a real space may be blocked from being supplied to a person who wears the HMD. Thus, a technology such as augmented reality (AR) which is a technology for displaying an artificially generated image so as to be superimposed on a video of the real space or a technology such as mixed reality (MR) for establishing a new space in which a real object and a virtual object influence each other in real time by merging of a real space and a virtual space have been suggested.

Here, the artificially generated image is displayed so as to be superimposed on an image captured by a capturing device such as a camera in the AR technology, and the MR technology is different from the AR technology in that a user who wears the HMD can directly and visually perceive a state of the real space through a transmissive display in real time.

In the virtual object display system according to the present exemplary embodiment, a configuration which allows a user to visually perceive as if an artificially generated virtual object is present in the real space visually perceived by the user in real time is achieved by using such an MR technology.

As shown in FIG. 1, the virtual object display system according to the present exemplary embodiment includes multiple head-mounted display (hereinafter, abbreviated to HMD) 10 that are respectively worn on the heads of the users, and a management server 20 that manages attribute information items of virtual objects which are respectively displayed on the HMDs 10, and a wireless LAN terminal 30.

The HMD (head-mounted display apparatus) 10 is used while being worn on the head of the user, and includes a transmissive display through which the real space is able to be visually perceived. In such a configuration, the user can visually perceive a state of the outside through the transmissive display. The HMD 10 displays the virtual object on the transmissive display, and thus, the user can visually perceive as if the virtual object is present in the real space.

The HMDs 10 are connected to the management server 20 by transmitting and receiving data items to and from the wireless LAN terminal 30 via a wireless communication line such as Wi-Fi or Bluetooth (registered trademark).

Attribute information items such as color, display positions, shapes, and sizes of the virtual objects to be displayed on the HMDs 10 are stored in the management server 20.

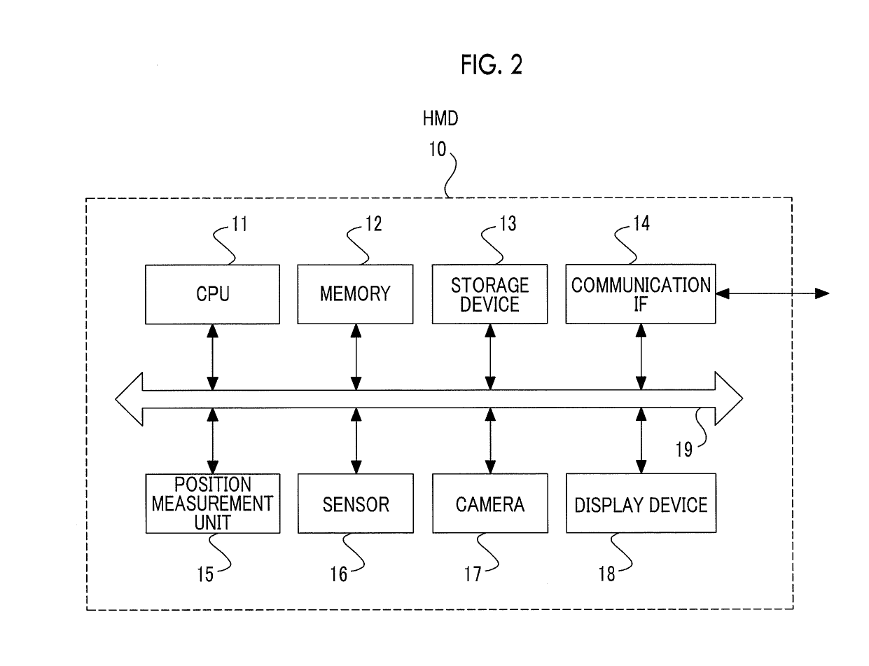

Hereinafter, a hardware configuration of the HMD 10 shown in FIG. 1 is illustrated in FIG. 2.

As shown in FIG. 2, the HMD 10 includes a CPU 11, a memory 12, a storage device 13 such as a flash memory, a communication interface (IF) 14 that transmits and receives data items to and from an external device such as the management server 20 via the wireless communication line, a position measurement unit 15 that measures a position of the HMD by using a system such as the GPS, a sensor 16 such as an accelerometer or a gyroscope (angular velocity sensor), a camera 17 for capturing an image of the outside, and a display device 18 that displays the virtual object. These constituent elements are connected to each other through a control bus 19.

The CPU 11 controls an operation of the HMD 10 by performing a predetermined process based on a control program stored in the memory 12 or the storage device 13.

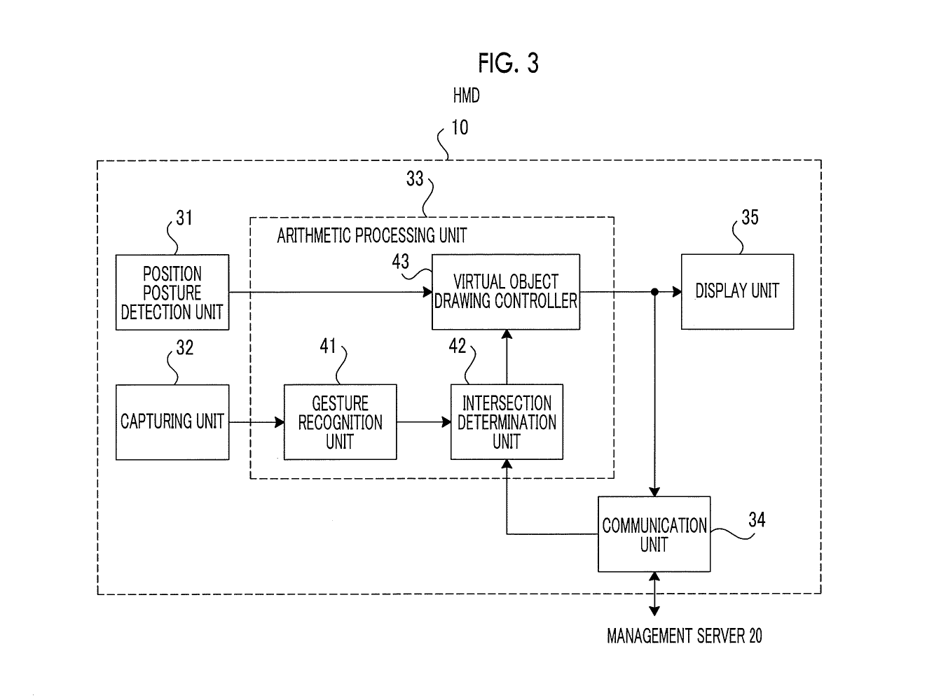

FIG. 3 is a block diagram showing a functional configuration of the HMD 10 realized by executing the control program.

As shown in FIG. 3, the HMD 10 according to the present exemplary embodiment includes a position posture detection unit 31, a capturing unit 32, an arithmetic processing unit 33, a communication unit 34, and a display 35. The arithmetic processing unit 33 includes a gesture recognition unit 41, an intersection determination unit 42, and a virtual object drawing controller 43.

The position posture detection unit 31 detects a position of the HMD based on positional information by a GPS reception device, or detects a change of a posture of the HMD based on the accelerometer or an output signal of the accelerometer.

The capturing unit 32 captures an image of the surrounding real space of the HMD.

The arithmetic processing unit 33 draws an image of the virtual object to be displayed on the display 35 based on the image of the surrounding real space captured by the capturing unit 32 and the positional information or information of the posture change of the HMD detected by the position posture detection unit 31.

The communication unit 34 transmits the attribute information of the virtual object generated by the arithmetic processing unit 33 or the positional information of the HMD to the management server 20, or receives the attribute information of the virtual object to be displayed on another HMD 10 transmitted from the management server 20.

For example, the display 35 is a transmissive display through which the real space is able to be visually perceived, and displays the image of the virtual object generated by the arithmetic processing unit 33 by using a holography technology.

The gesture recognition unit 41 recognizes a position of a fingertip of the user who wears the HMD from the image captured by the capturing unit 32, or recognizes a position of a person who approaches the HMD.

The intersection determination unit 42 determines whether or not the fingertip of the user recognized by the gesture recognition unit 41 intersects with the position of the drawn virtual object and whether or not a part of the person who is approaching the HMD recognized by the gesture recognition unit 41 intersects with the position of the drawn virtual object.

The virtual object drawing controller 43 controls such that a wall-shaped opaque virtual object is drawn so as to block visibility of the user based on the image captured by the capturing unit 32 and the drawn virtual object is displayed on the display 35 as if the virtual object is present in the real space.

Specifically, the virtual object drawing controller 43 controls such that the wall-shaped opaque virtual object is displayed on the display 35 at least in front of the user who wears the HMD.

More specifically, the virtual object drawing controller 43 controls such that the wall-shaped opaque virtual object is displayed on the display 35 so as to surround a surrounding area of the user who wears the HMD.

In a case where the position of the fingertip of the user is recognized by the gesture recognition unit 41, the virtual object drawing controller 43 displays a four-wall-shaped virtual object on the display 35 in a square pillar shape of which a length of one side is approximately twice a distance between the HMD and the position of the fingertip of the user recognized by the gesture recognition unit 41.

In a case where the fingertip of the user recognized by the gesture recognition unit 41 intersects with the position of the drawn virtual object, the virtual object drawing controller 43 changes the virtual object displayed on the display 35 to be translucent or removes the virtual object.

In a case where the fingertip of the user recognized by the gesture recognition unit 41 intersects with the position of the drawn virtual object, the virtual object drawing controller 43 changes at least one attribute of color, display position, a shape, or a size of the virtual object displayed on the display 35 depending on a position touched on the virtual object.

In a case where a part of a fingertip of a person who is approaching the HMD, which is recognized by the gesture recognition unit 41 intersects with the position of the drawn virtual object, the virtual object drawing controller 43 changes the virtual object displayed on the display 35 to be translucent or removes the virtual object.

In a case where a preset event occurs, the virtual object drawing controller 43 controls such that character information corresponding to the occurred event is displayed on the drawn virtual object. For example, in a case where an event that emergency information such as earthquake early warning is received in the management server 20 occurs, character information such as “earthquake occurs!” is displayed on the virtual object.

The management server 20 controls such that the attribute information items of the virtual objects which are respectively displayed on the multiple HMDs 10 are stored and the virtual object displayed on the display of a certain HMD 10 is also displayed on the display of different HMD 10.

Different IDs (identification information items) are set to the multiple HMDs 10, and thus, the management server 20 may display the virtual object displayed on a certain HMD 10 for only the HMD 10 to which a previously registered ID is set.

Each of the multiple HMDs 10 includes the position posture detection unit 31 that detects the current position of the HMD. Thus, the management server 20 may control such that the virtual object displayed on a certain HMD 10 is displayed on only another HMD 10 present within a preset distance, for example, 10 m.

The management server 20 may control such that the virtual object is displayed on another HMD 10 in a state in which character information is displayed on the outside of the virtual object displayed on a certain HMD 10. For example, if the character information such as the virtual object is displayed on another HMD 10 in a state in which “at work” is displayed on the outside of the wall-shaped virtual object displayed on a certain HMD 10, it may be expected that the user who wears another HMD 10 knows that the user existing in the wall-shaped virtual object is at work and does not disturb.

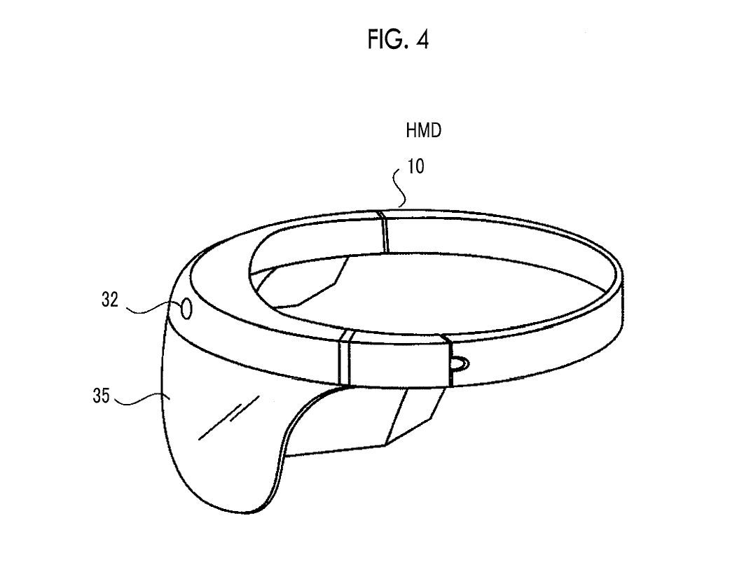

Next, an external appearance of the above-described HMD 10 is shown in FIG. 4. As shown in FIG. 4, the HMD 10 includes a transmissive display 35 capable of allowing the user who wears the HMD to visually perceive the state of the outside. The capturing unit 32 for capturing the state of the outside is provided at a part of the HMD 10, and may capture an image of the state of the outside visually perceived by the user through the transparent display 35.

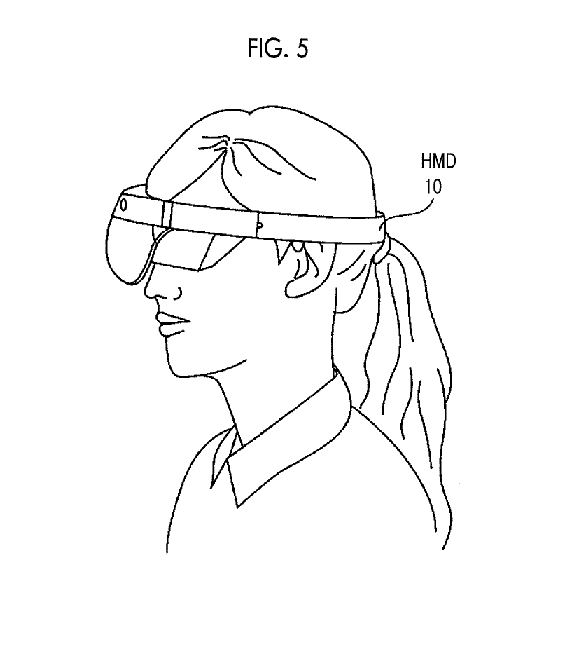

A state in which the HMD 10 is worn on the head is shown in FIG. 5. Referring to FIG. 5, it can be seen that the eyes of the user who wears the HMD 10 are covered with the display 35, but the user may visually perceive the state of the outside since the display 35 is a transmissive type.

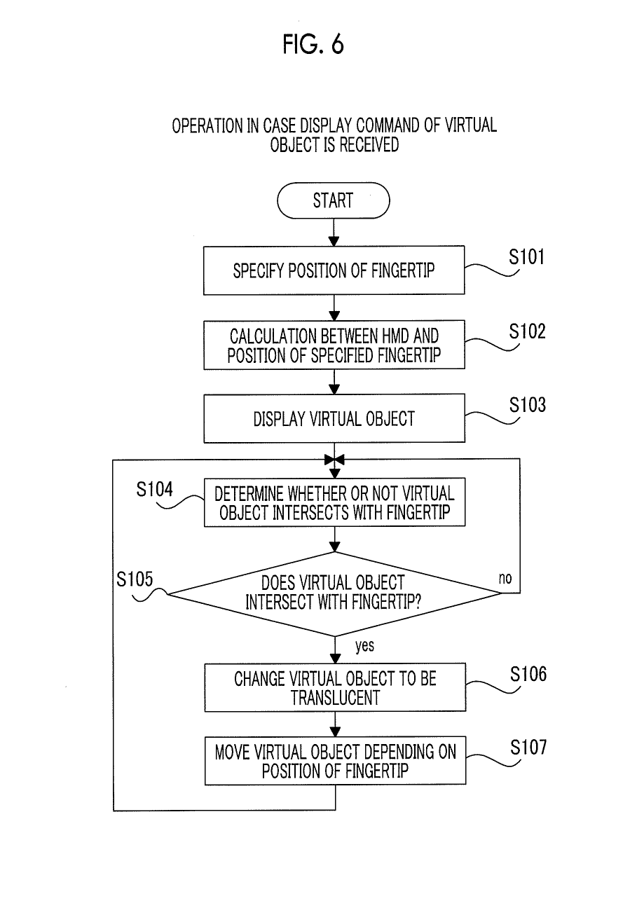

Hereinafter, an operation in a case where a display command of the virtual object is received in the HMD 10 according to the present exemplary embodiment will be described with reference to a flowchart of FIG. 6. For example, the user pushes a switch attached to the HMD 10 and thus, the display command of the virtual object is given.

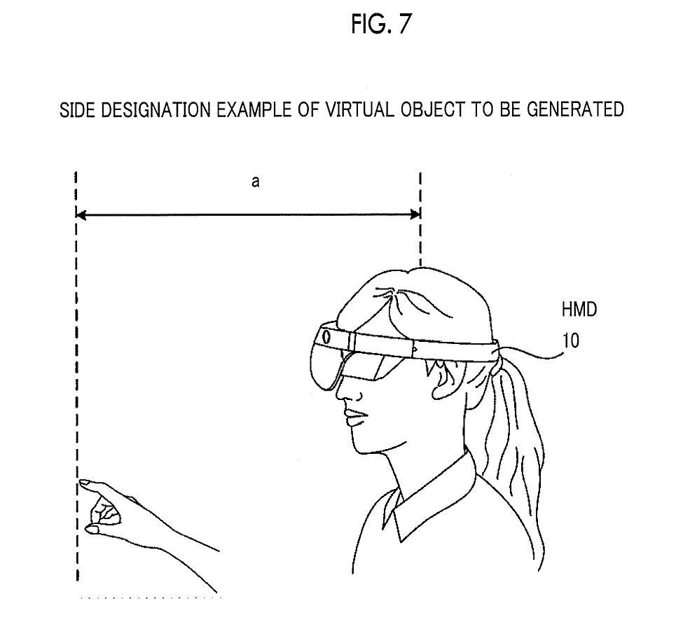

Initially, the user stretches out their arm and causes the capturing unit 32 to capture their fingertip, as shown in FIG. 7. In so doing, the gesture recognition unit 41 recognizes and specifies the position of the fingertip of the user from the image captured by the capturing unit 32 (step S101).

The gesture recognition unit 41 calculates a distance between a position of the specified fingertip and the HMD from the image captured by the capturing unit 32 (step S102). Here, it is assumed that the calculated distance is a as shown in FIG. 7.

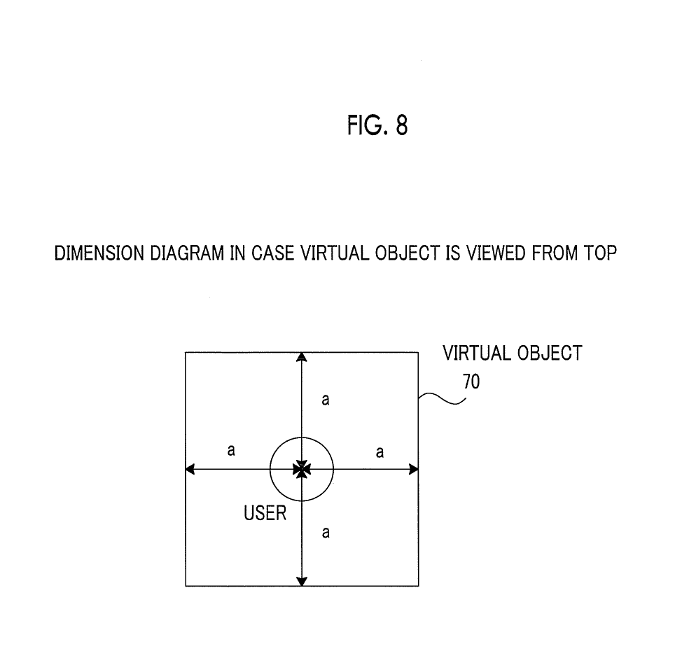

In so doing, as shown in FIG. 8, virtual object drawing controller 43 draws a four-wall-shaped virtual object 70 in a square pillar shape of which a length of one side is approximately twice the distance a between the HMD and the position of the fingertip of the user recognized by the gesture recognition unit 41, and displays the drawn virtual object on the display 35.

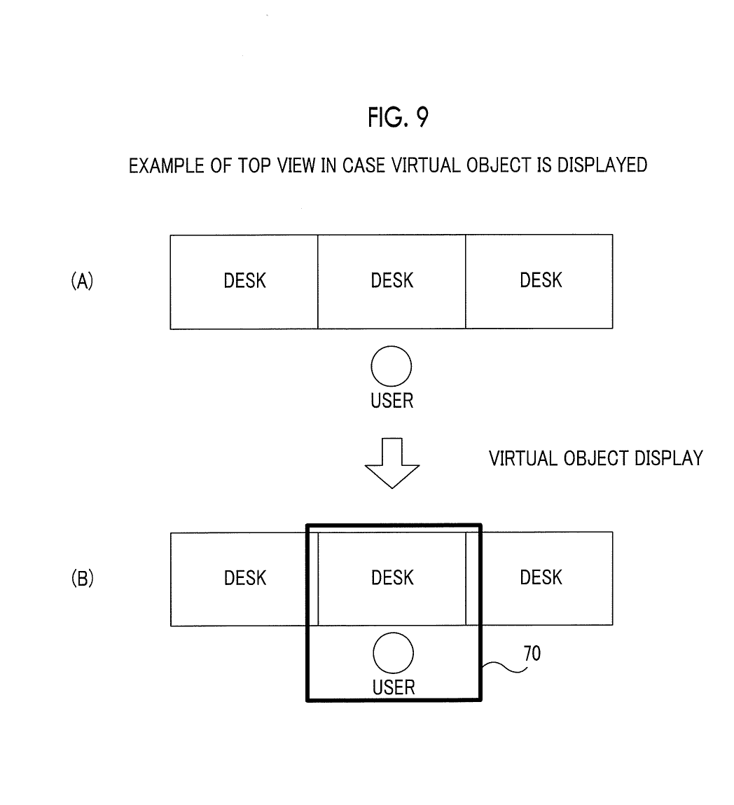

FIG. 9 shows an example of a top view of the virtual object 70 when the virtual object 70 is displayed. FIG. 9(a) is a diagram showing a state before the virtual object 70 is displayed, and FIG. 9(b) is a diagram showing a state after the virtual object 70 is displayed. In FIG. 9(b), the virtual object 70 which is a four-wall-shaped object is displayed so as to be arranged around the user who seats in front of a desk.

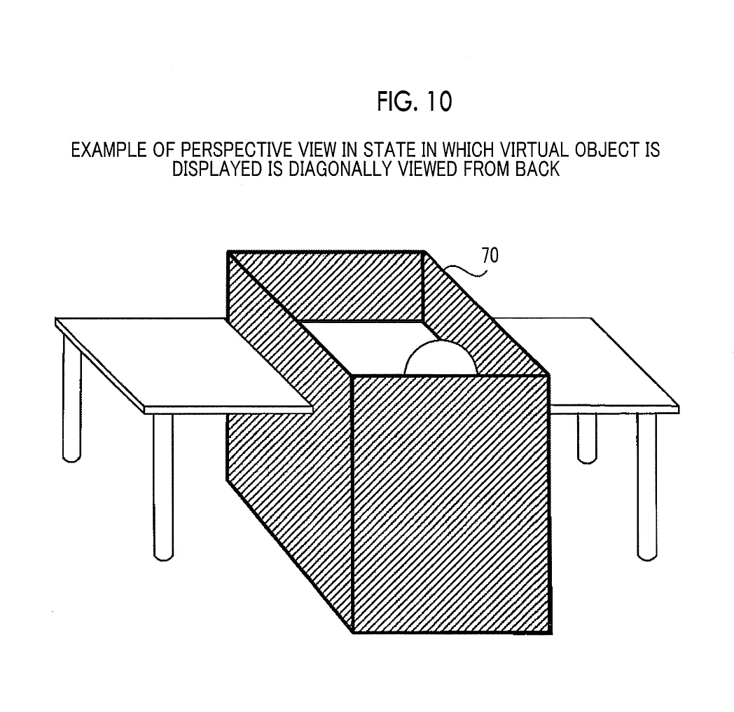

FIG. 10 is a perspective view in a case where a state in which the virtual object 70 is displayed is diagonally viewed from the back.

FIGS. 9 and 10 are schematic diagrams showing a display position and a shape of the virtual object 70, and the virtual object 70 is not viewed by a person who does not wear the HMD 10.

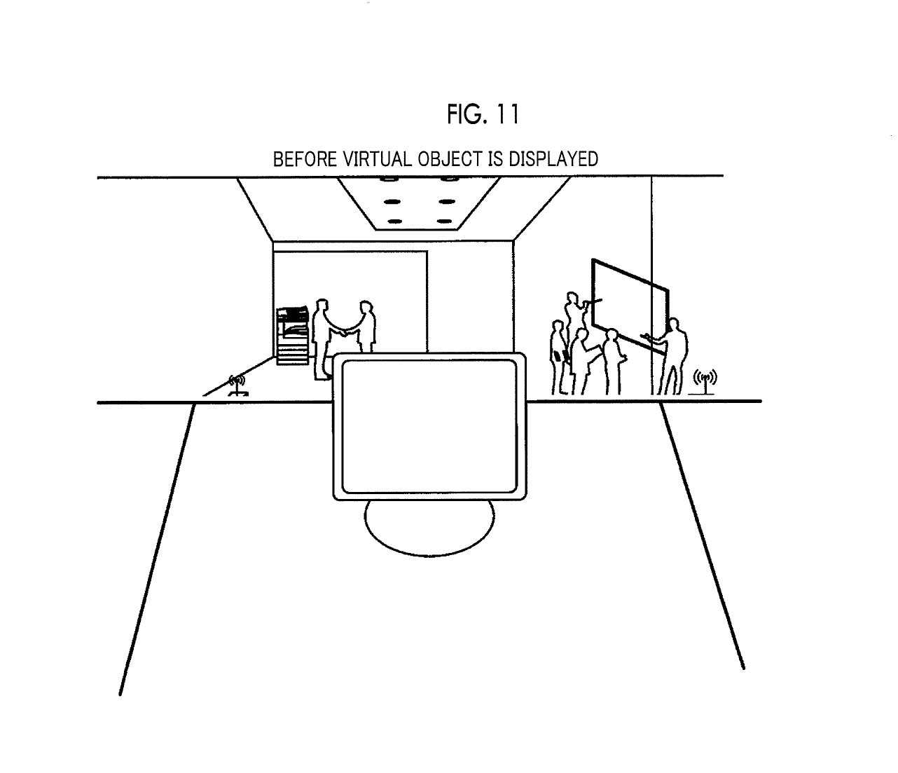

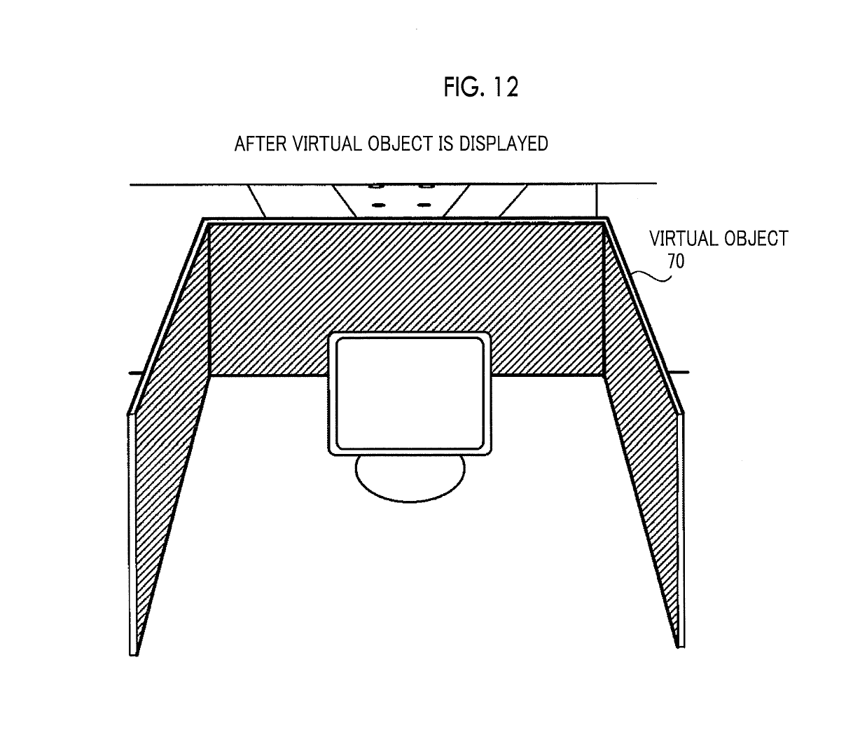

Hereinafter, how the visibility of the user is changed by the fact that the virtual object 70 is displayed on the display 35 will be described with reference to FIGS. 11 and 12.

FIG. 11 is a schematic diagram showing a state of the visibility of the user before the virtual object 70 is displayed on the display 35. FIG. 12 is a schematic diagram showing a state of the visibility of the user after the virtual object 70 is displayed on the display 35.

Referring to FIG. 12, it can be seen that the virtual object 70 is displayed so as to be present around the desk on which the user seats.

Referring back to the description of the flowchart of FIG. 6, after the virtual object 70 is displayed, the intersection determination unit 42 determines whether or not the fingertip of the user which is captured by the capturing unit 32 and is recognized by the gesture recognition unit 41 intersects with the displayed virtual object 70 (step S104).

In a case where it is determined that the fingertip of the user intersects with the displayed virtual object 70 (Yes in step S105), the virtual object drawing controller 43 changes the virtual object 70 to be translucent or removes the virtual object depending on the intersecting position or time, or moves the display position of the virtual object 70 or modifies the shapes thereof depending on the position of the fingertip (steps S106 and S107).

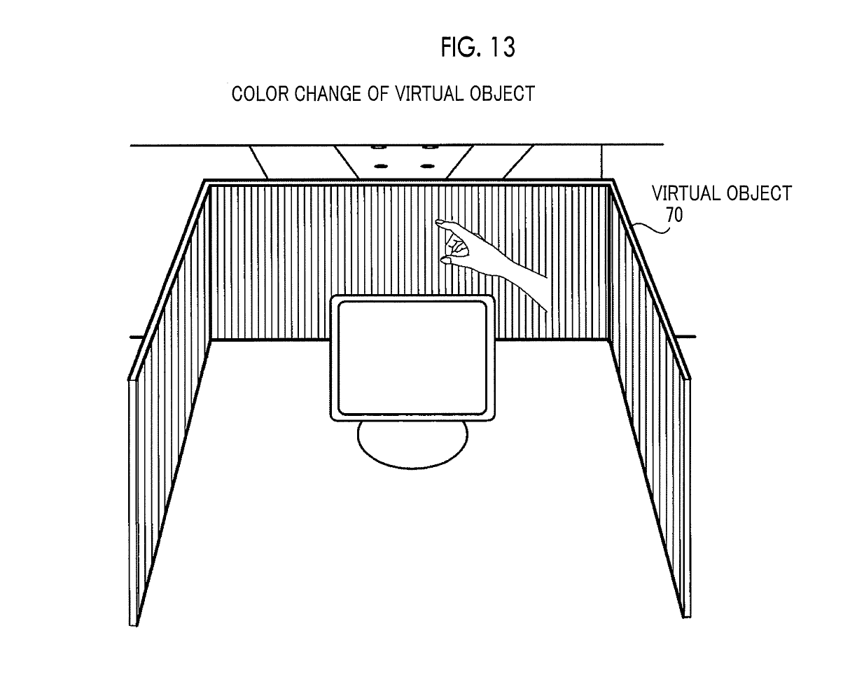

For example, in a case where the user touches the virtual object 70 with their fingertip only for a short time, the color of the virtual object 70 may be cyclically changed as shown in FIG. 13. For example, the color of the virtual object 70 is sequentially changed such that the virtual object 70 is initially displayed in blue, is changed to be in green if the user touches the virtual object with their fingertip once, and is changed to be in red if the user touches next with their fingertip.

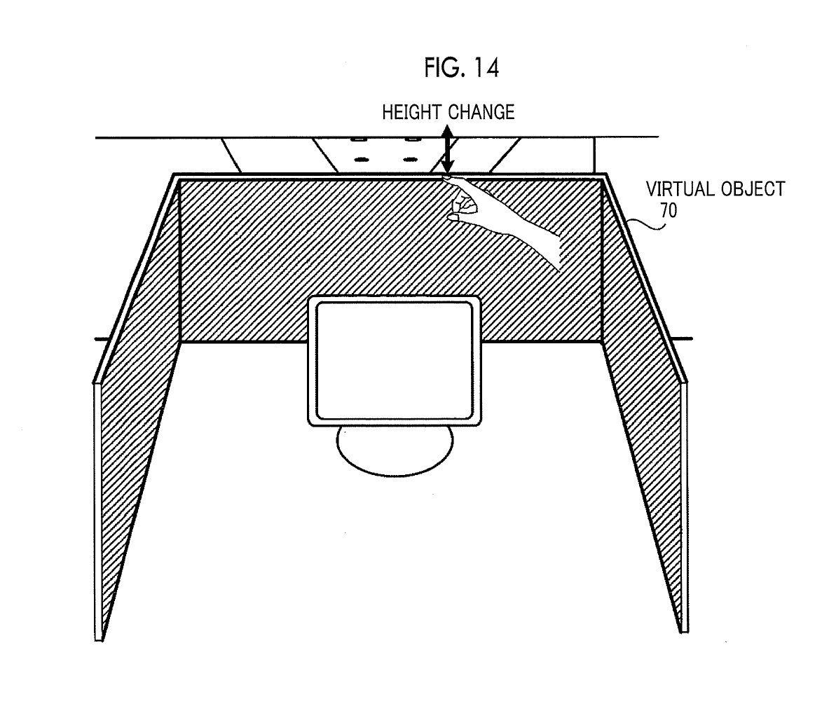

As shown in FIG. 14, the side of the virtual object is moved in parallel along the movement of the fingertip in a case where the user touches a specific side of the virtual object 70 with their fingertip for a predetermined time or longer. FIG. 14 shows a state in which a height of the wall-shaped virtual object 70 is changed.

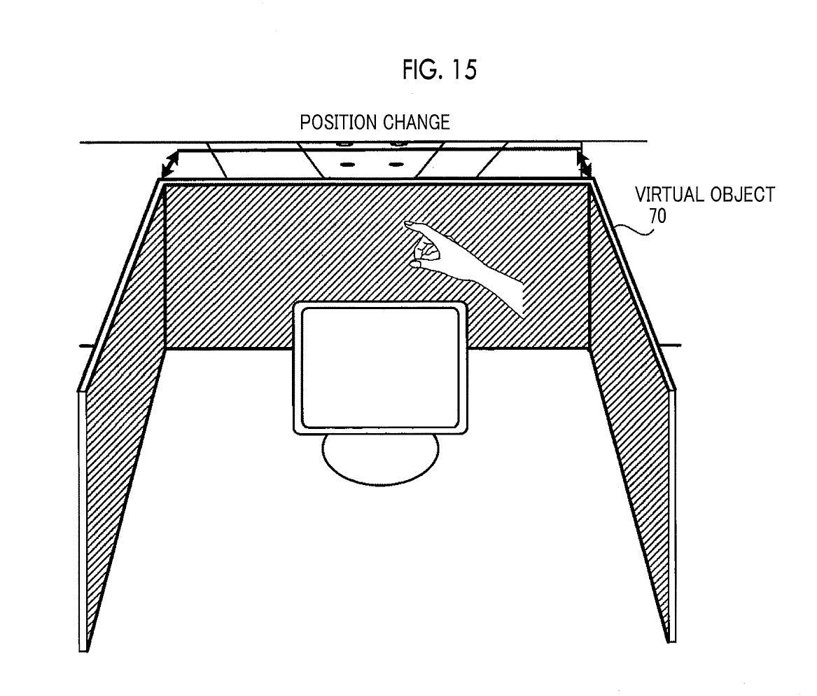

As shown in FIG. 15, the user touches a certain surface of the virtual object 70 for a predetermined time or longer, and thus, the display position may be changed by moving the surface in parallel along the movement of the fingertip. In FIG. 15, a state in which the display position is changed by moving the display position of the wall-shaped virtual object 70 present in front of the user to a depth direction.

The user can focus on their work by virtually displaying the virtual object 70 to the user, but the user does not realize a change of a surrounding situation since the user is able to view the surrounding situation.

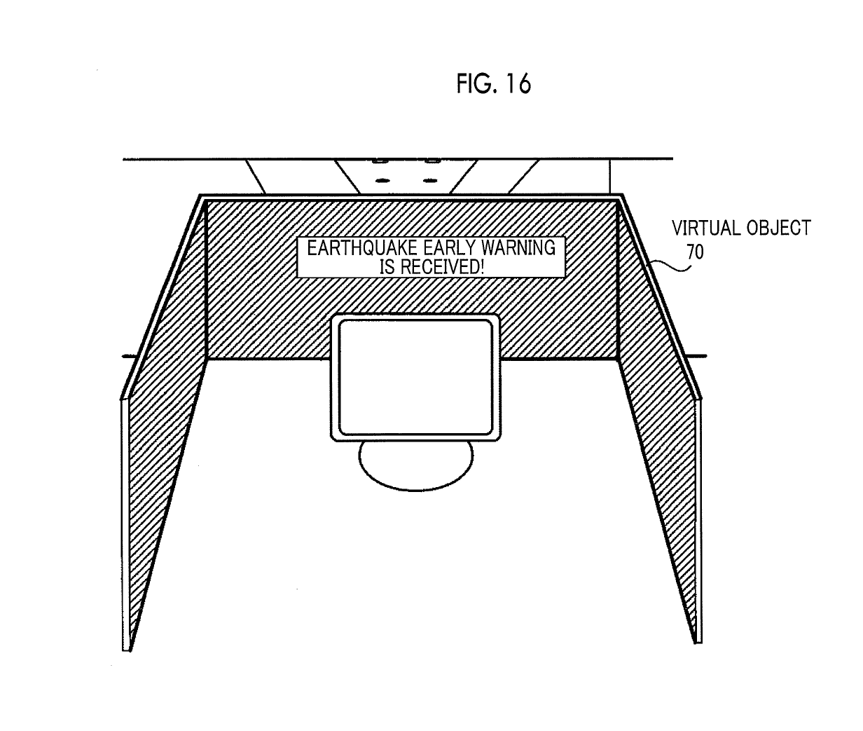

Thus, in a case where the management server 20 detects the occurrence of a certain specific event, the fact that the event occurs may be displayed on the virtual object 70 by the character information. For example, in a case where the management server 20 receives earthquake early warning, the management server transmits the notification indicating that the earthquake early warning is received to the HMD 10, and the virtual object drawing controller 43 within the HMD 10 displays the character information such as “earthquake early warning is received!” on the virtual object 70 as shown in FIG. 16.

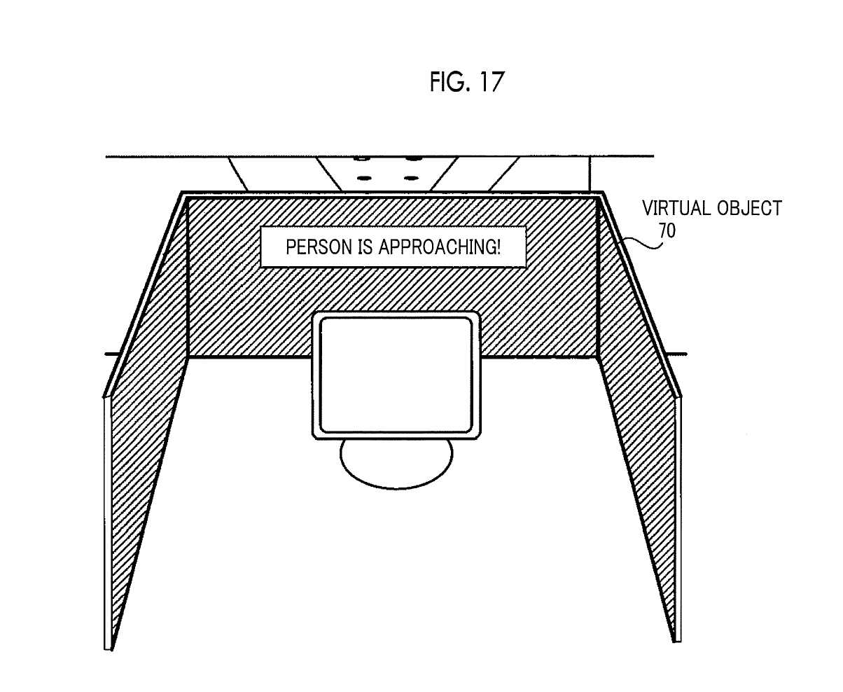

In a case where the gesture recognition unit 41 detects that the person approaches by the image captured by the capturing unit 32, the character information such as “person is approaching!” is displayed on the virtual object 70, as shown in FIG. 17.

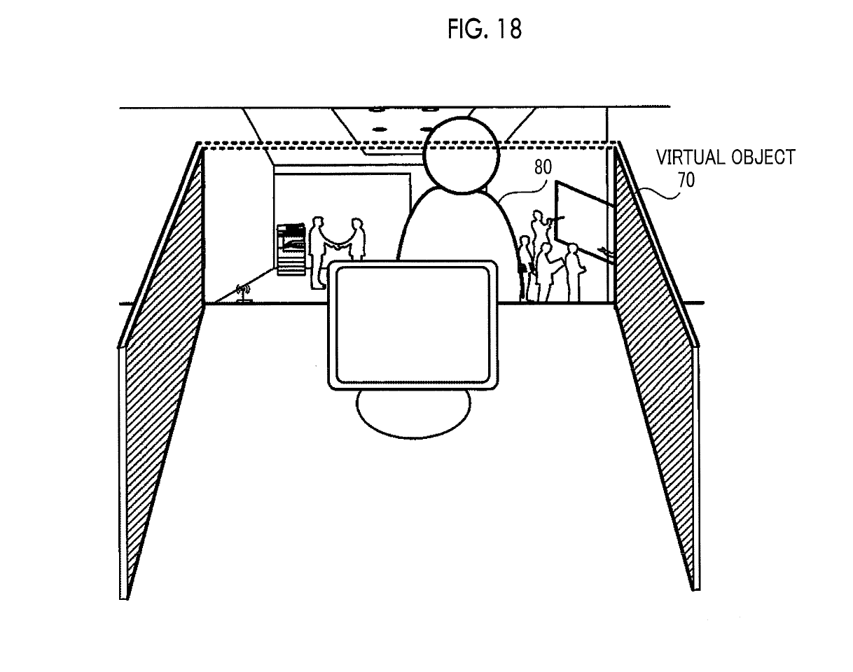

In a case where the person further approaches and the intersection determination unit 42 determines whether or not the person who approaches intersects with the virtual object 70, the virtual object drawing controller 43 changes a surface of the virtual object intersecting with an approaching person 80 to be translucent or removes the virtual object, as shown in FIG. 18.

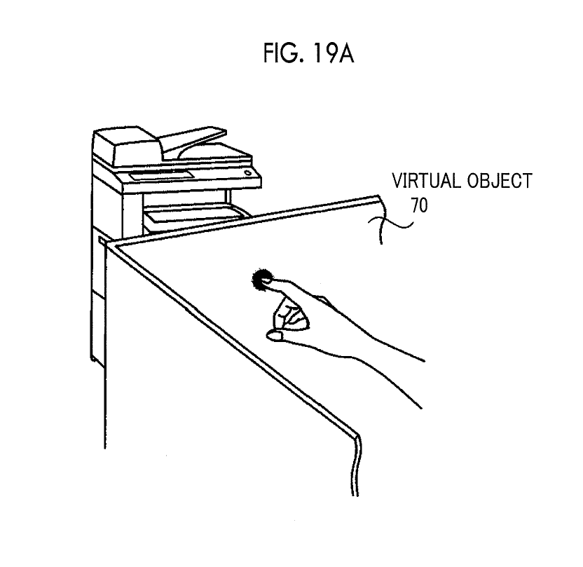

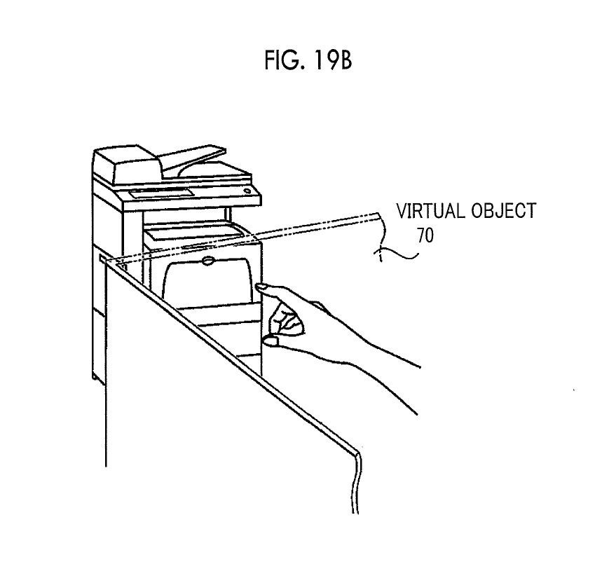

For example, in a case where the user wants to know the surrounding situation, the user performs a touch operation on a certain surface of the virtual object 70 as shown in FIG. 19A with their fingertip, and thus, the virtual object drawing controller 43 changes the surface to be translucent or removes the virtual object as shown in FIG. 19B.

The attribute information of the virtual object 70 displayed on a certain HMD 10 is stored in the management server 20.

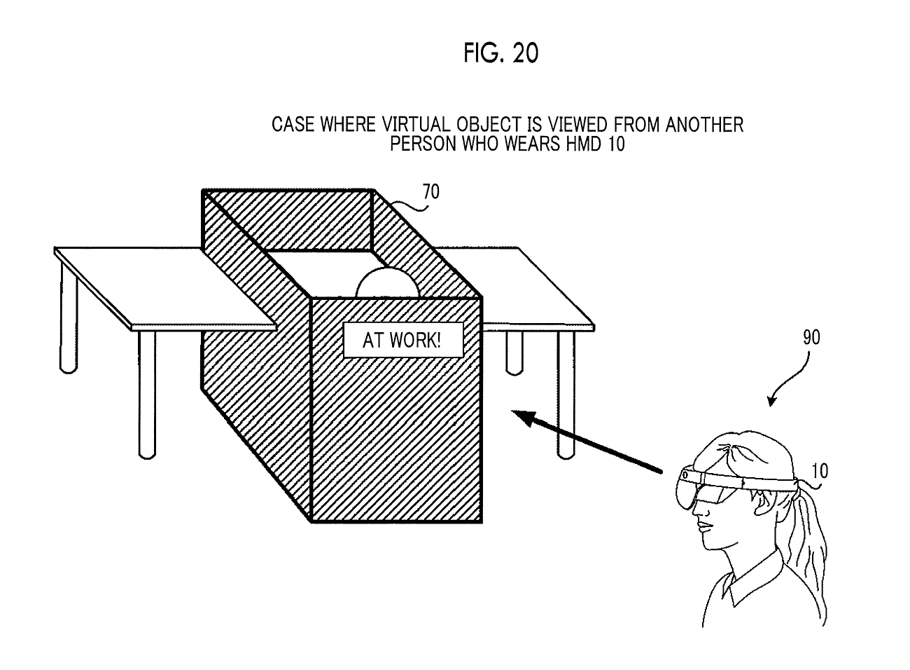

For example, as shown in FIG. 20, the virtual object 70 is displayed on the HMD 10 of another user 90 different from the user who displays the virtual object 70 and is at work.

The identification information items are respectively associated with the HMDs 10, and thus, the virtual object 70 around the HMD is displayed on only the HMD 10 having specific identification information.

The character information previously input to the outside of the virtual object 70 may be displayed, and the character information such as “at work!” is displayed in the example of FIG. 20.

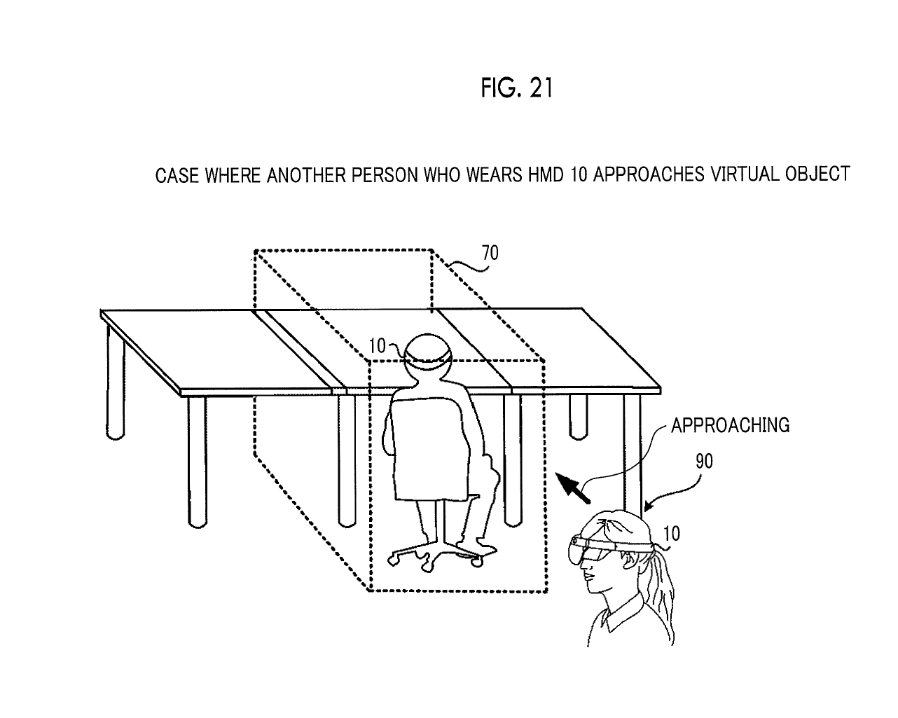

In such a case, since actual positions of the HMDs 10 are managed by the management server 20, in a case where it is determined that two HMDs 10 approach each other within a preset distance, for example, 2 m, the virtual object drawing controller 43 may recognize that two HMDs approach each other by changing the displayed virtual object 70 to be translucent or removing the virtual object, as shown in FIG. 21.

The virtual object drawing controller 43 calculates a distance in a depth direction from the image captured by the capturing unit 32, and determines a position in which the virtual object 70 is superimposed on the image of another user. Thus, a drawing process is performed such that an image of a position is farther than the display position of the virtual object 70.

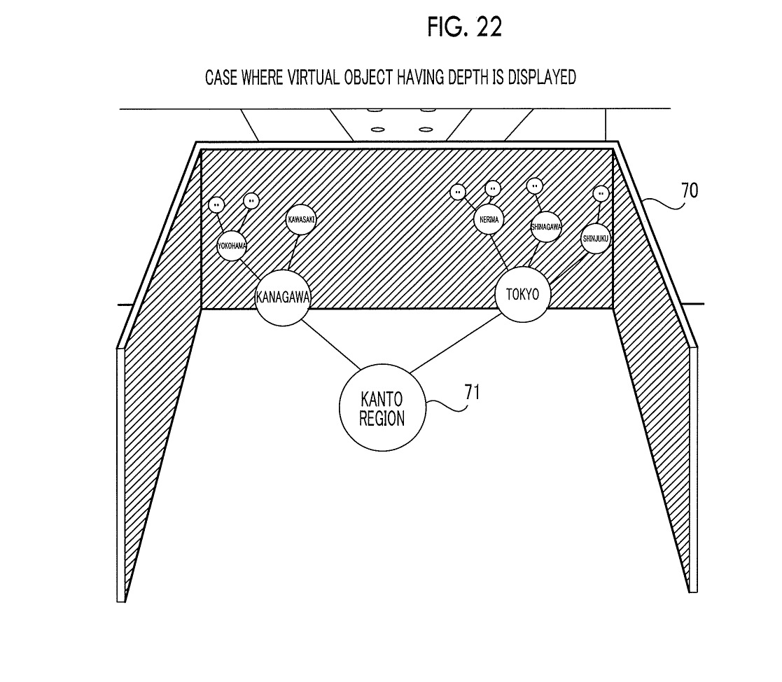

However, as shown in FIG. 22, in a case where a certain virtual object 71 having a depth direction is displayed, even in a case where a depth distance of the virtual object 71 is farther than the display position of the virtual object 70, the virtual object 71 is displayed in front of the virtual object 70. For example, in a case where a wall-shaped opaque virtual object 71 is displayed in front of the virtual object 70 by 1 m and the depth of the virtual object 71 is 4 m, the virtual object 71 is displayed in front of the virtual object 70, and thus, it may be possible to display the entire virtual object 71 such that the user can view the entire virtual object 71.

### MODIFICATION EXAMPLE

Although it has been described in the exemplary embodiment that a planar-wall-shaped virtual object is displayed, the present invention is not limited thereto. The present invention may also be similarly applied to a case where a columnar virtual object or a spherical virtual object is displayed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A head-mounted display apparatus comprising:
a capturing unit that captures an image of a real space;
a transmissive display through which the real space is able to be visually perceived; and
a drawing controller that controls such that a wall-shaped opaque virtual object is drawn so as to block visibility of a user based on the image captured by the capturing unit and the virtual object is displayed on the transmissive display as if the virtual object is present in the real space.

2. The head-mounted display apparatus according to claim 1,
wherein the drawing controller controls the transmissive display such that the wall-shaped opaque virtual object is displayed at least in front of a user who wears the head-mounted display apparatus.

3. The head-mounted display apparatus according to claim 1,
wherein the drawing controller controls the transmissive display such that the wall-shaped opaque virtual object is displayed so as to surround a surrounding area of the user who wears the head-mounted display apparatus.

4. The head-mounted display apparatus according to claim 1, further comprising:
a recognition unit that recognizes a position of a fingertip of a user who wears the head-mounted display apparatus from the image captured by the capturing unit,
wherein the drawing controller displays a four-wall-shaped virtual object in a square pillar shape of which a length of one side is approximately twice a distance between the position of the fingertip of the user recognized by the recognition unit and the head-mounted display apparatus on the transmissive display.

5. The head-mounted display apparatus according to claim 1, further comprising:
a recognition unit that recognizes a position of a fingertip of a user who wears the head-mounted display apparatus from the image captured by the capturing unit,
wherein the drawing controller changes the virtual object displayed on the transmissive display to be translucent or removes the virtual object in a case where the fingertip of the user recognized by the recognition unit intersects with a position of the drawn virtual object.

6. The head-mounted display apparatus according to claim 2, further comprising:
a recognition unit that recognizes a position of a fingertip of a user who wears the head-mounted display apparatus from the image captured by the capturing unit,
wherein the drawing controller changes the virtual object displayed on the transmissive display to be translucent or removes the virtual object in a case where the fingertip of the user recognized by the recognition unit intersects with a position of the drawn virtual object.

7. The head-mounted display apparatus according to claim 3, further comprising:
a recognition unit that recognizes a position of a fingertip of a user who wears the head-mounted display apparatus from the image captured by the capturing unit,
wherein the drawing controller changes the virtual object displayed on the transmissive display to be translucent or removes the virtual object in a case where the fingertip of the user recognized by the recognition unit intersects with a position of the drawn virtual object.

8. The head-mounted display apparatus according to claim 4, further comprising:
a recognition unit that recognizes a position of a fingertip of a user who wears the head-mounted display apparatus from the image captured by the capturing unit,
wherein the drawing controller changes the virtual object displayed on the transmissive display to be translucent or removes the virtual object in a case where the fingertip of the user recognized by the recognition unit intersects with a position of the drawn virtual object.

9. The head-mounted display apparatus according to claim 1, further comprising:
a recognition unit that recognizes a position of a fingertip of a user who wears the head-mounted display apparatus from the image captured by the capturing unit,
wherein the drawing controller changes at least one attribute of color, a display position, a shape, or a size of the virtual object displayed on the transmissive display depending on a position touched on the virtual object in a case where the fingertip of the user recognized by the recognition unit intersects with a position of the drawn virtual object.

10. The head-mounted display apparatus according to claim 2, further comprising:
a recognition unit that recognizes a position of a fingertip of a user who wears the head-mounted display apparatus from the image captured by the capturing unit,
wherein the drawing controller changes at least one attribute of color, a display position, a shape, or a size of the virtual object displayed on the transmissive display depending on a position touched on the virtual object in a case where the fingertip of the user recognized by the recognition unit intersects with a position of the drawn virtual object.

11. The head-mounted display apparatus according to claim 3, further comprising:
a recognition unit that recognizes a position of a fingertip of a user who wears the head-mounted display apparatus from the image captured by the capturing unit,
wherein the drawing controller changes at least one attribute of color, a display position, a shape, or a size of the virtual object displayed on the transmissive display depending on a position touched on the virtual object in a case where the fingertip of the user recognized by the recognition unit intersects with a position of the drawn virtual object.

12. The head-mounted display apparatus according to claim 4, further comprising:
a recognition unit that recognizes a position of a fingertip of a user who wears the head-mounted display apparatus from the image captured by the capturing unit,
wherein the drawing controller changes at least one attribute of color, a display position, a shape, or a size of the virtual object displayed on the transmissive display depending on a position touched on the virtual object in a case where the fingertip of the user recognized by the recognition unit intersects with a position of the drawn virtual object.

13. The head-mounted display apparatus according to claim 1, further comprising:
a recognition unit that recognizes a position of a person who approaches from the image captured by the capturing unit,
wherein the drawing controller changes the virtual object displayed on the transmissive display to be translucent or removes the virtual object in a case where a part of the person recognized by the recognition unit intersects with a position of the drawn virtual object.

14. The head-mounted display apparatus according to claim 2, further comprising:
a recognition unit that recognizes a position of a person who approaches from the image captured by the capturing unit,
wherein the drawing controller changes the virtual object displayed on the transmissive display to be translucent or removes the virtual object in a case where a part of the person recognized by the recognition unit intersects with a position of the drawn virtual object.

15. The head-mounted display apparatus according to claim 3, further comprising:
a recognition unit that recognizes a position of a person who approaches from the image captured by the capturing unit,
wherein the drawing controller changes the virtual object displayed on the transmissive display to be translucent or removes the virtual object in a case where a part of the person recognized by the recognition unit intersects with a position of the drawn virtual object.

16. The head-mounted display apparatus according to claim 1,
wherein the drawing controller controls such that character information corresponding to a preset event is displayed on the drawn virtual object in a case where the event occurs.

17. A virtual object display system comprising:
a plurality of head-mounted display apparatuses that each includes a capturing unit which captures an image of a real space, a transmissive display through which the real space is able to be visually perceived, and a drawing controller which controls such that a wall-shaped opaque virtual object is drawn so as to block visibility of a user based on the image captured by the capturing unit and the virtual object is displayed on the transmissive display as if the virtual display is present in the real space; and
a management server that controls such that attribute information items of the virtual objects which are respectively displayed on the transmissive displays of the plurality of head-mounted display apparatuses are stored and the virtual object displayed on the transmissive display of a certain head-mounted display apparatus is also displayed on the transmission display of a different head-mounted display apparatus.

18. The virtual object display system according to claim 17,
wherein identification information items are respectively set to the plurality of head-mounted display apparatuses, and
the management server controls such that the virtual object displayed on another head-mounted display apparatus is displayed on the head-mounted display apparatus to which previously registered identification information is set.

19. The virtual object display system according to claim 17,
wherein the plurality of head-mounted display apparatuses each includes a detection unit that detects a current position of the head-mounted display apparatus, and
the management server controls such that the virtual object displayed on a certain head-mounted display apparatus is displayed on only another head-mounted display apparatus present within a preset distance.

20. The virtual object display system according to claim 17,
wherein the management server controls such that the virtual object is displayed on another head-mounted display apparatus in a state in which character information is displayed on the outside of the virtual object displayed on a certain head-mounted display apparatus.
